(19) United States
(12) Patent Application Publication
(10) Pub. No.: US 2009/0151391 A1
(43) Pub. Date: Jun. 18, 2009

(54) LNG FACILITY EMPLOYING A HEAVIES ENRICHING STREAM

(75) Inventors: Shawn S. Huang, Spring, TX (US); Harry J. Crofton, Houston, TX (US); G. Dennis Cook, Kingwood, TX (US); Jong Juh Chen, Sugar Land, TX (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 11/954,778

(22) Filed: Dec. 12, 2007

(51) Int. Cl. F25J 3/00; G06F 17/50; F17C 1/00

(52) U.S. Cl. 62/620; 703/13; 62/53.1

(57) ABSTRACT

An LNG facility employing a heavies enriching stream to increase the flexibility of the LNG facility by allowing feed gas streams of widely varying compositions to be processed while producing on-spec LNG.

### BACKGROUND OF THE INVENTION

1. Field of the Invention

This invention relates to methods and apparatuses for liquefying natural gas. In another aspect, the invention concerns a liquefied natural gas (LNG) facility employing a heavies enriching stream.

2. Description of the Prior Art

Cryogenic liquefaction is commonly used to convert natural gas into a more convenient form for transportation and/or storage. Because liquefying natural gas greatly reduces its specific volume, large quantities of natural gas can be economically transported and/or stored in liquefied form.

Transporting natural gas in its liquefied form can effectively link a natural gas source with a distant market when the source and market are not connected by a pipeline. This situation commonly arises when the source of natural gas and the market for the natural gas are separated by large bodies of water. In such cases, liquefied natural gas (LNG) can be transported from the source to the market using specially designed ocean-going LNG tankers.

Storing natural gas in its liquefied form can help balance out periodic fluctuations in natural gas supply and demand. In particular, LNG can be “stockpiled” for use when natural gas demand is low and/or supply is high. As a result, future demand peaks can be met with LNG from storage, which can be vaporized as demand requires.

Several methods exist for liquefying natural gas. Some methods produce a pressurized LNG (PLNG) product that is useful, but requires expensive pressure-containing vessels for storage and transportation. Other methods produce an LNG product having a pressure at or near atmospheric pressure. In general, these non-pressurized LNG production methods involve cooling a natural gas stream via indirect heat exchange with one or more refrigerants and then expanding the cooled natural gas stream to near atmospheric pressure. In addition, most LNG facilities employ one or more systems to remove contaminants (e.g., water, acid gases, nitrogen, and ethane and heavier components) from the natural gas stream at different points during the liquefaction process.

In general, LNG facilities are designed and operated to provide LNG to a single market in a certain region of the world. Because natural gas specifications, such as, for example, higher heating value (HHV), Wobbe index, methane content, ethane content, C₃₊ content, and inerts content, vary widely throughout the world, LNG facilities are typically optimized to meet a certain set of specifications for a single market. Thus, most existing facilities are equipped only to process natural gas feed streams within a relatively narrow composition range. For example, when an LNG facility designed and operated to effectively process a lean (i.e., heavies-lean) natural gas feed stream is forced to process a rich natural gas stream due to, for example, change in feed gas source or upstream process upset, the plant's LNG production rate and product quality are adversely affected.

One proposed solution to managing natural gas feed streams having widely varying compositions is to constantly adjust the operating conditions of the distillation column(s) in the heavies removal zone based on the compositional changes in the feed gas. The flexibility of this proposed solution is typically limited by equipment constraints. In addition, frequently altering plant process conditions introduces operational instability and can result in large volumes of off-spec product and/or product loss. Another proposed solution is to equip LNG facilities with auxiliary process equipment (e.g. distillation columns, turboexpanders, and/or compressors) to be used when the facility processes feed gas outside its design composition range. The main drawbacks associated with this proposed solution are the increased capital cost and operational complexity associated with adding process equipment to a new or existing plant configuration.

Thus, a need exists for an LNG facility capable of managing natural gas feed streams having widely varying compositions in a way that maximizes the production of on-spec LNG product while minimizing capital and operating costs for the entire facility.

### SUMMARY OF THE INVENTION

In one embodiment of the present invention, there is provided a process for liquefying a natural gas stream in an LNG facility, the process comprising: (a) combining at least a portion of the natural gas stream with a heavies enriching stream to thereby form a heavies enriched natural gas stream; (b) separating at least a portion of the heavies enriched natural gas stream in a first distillation column to thereby provide a first overhead stream and a first bottoms stream; and (c) separating at least a portion of the first bottoms stream in a second distillation column to thereby provide a second bottoms stream, wherein the heavies enriching stream comprises at least a portion of the second bottoms stream.

In another embodiment of the present invention, there is provided a process for liquefying a natural gas stream in an LNG facility, the process comprising: (a) introducing a heavies enriching stream into the natural gas stream to thereby produce a heavies enriched natural gas stream; (b) separating at least a portion of the heavies enriched natural gas stream in a distillation column to thereby provide an overhead stream and a bottoms stream, wherein the heavies enriching stream comprises at least a portion of the bottoms stream; and (c) adjusting the flow rate of the heavies enriching stream introduced into the natural gas stream to maintain a C₃+/C₂ molar ratio in the heavies enriched natural gas stream of at least about 0.3:1.

In yet another embodiment of the present invention, there is provided an LNG facility comprising a natural gas feed conduit, a first distillation column, and a second distillation column. The first distillation column defines a first fluid inlet, upper outlet, and lower outlet. The first fluid inlet is coupled in fluid flow communication with the natural gas feed conduit. The second distillation column defines a second fluid inlet, upper outlet, and lower outlet. The second fluid inlet is coupled in fluid flow communication with the first lower outlet. The second lower outlet is coupled in fluid flow communication with the natural gas feed conduit at an enrichment location upstream of the first distillation column.

### BRIEF DESCRIPTION OF THE FIGURES

Certain embodiments of the present invention are described in detail below with reference to the enclosed figures, wherein:

FIG. 1a is a simplified overview of a cascade-type LNG facility configured in accordance with one embodiment of the present invention;

FIG. 1b is a flow chart of the major steps involved in executing one embodiment of the present invention; and

FIG. 2 is a schematic diagram a cascade-type LNG facility configured in accordance with one embodiment of present invention.

### DETAILED DESCRIPTION

The present invention can be implemented in a facility used to cool natural gas to its liquefaction temperature to thereby produce liquefied natural gas (LNG). The LNG facility generally employs one or more refrigerants to extract heat from the natural gas and then reject the heat to the environment. Numerous configurations of LNG systems exist, and the present invention may be implemented many different types of LNG systems.

In one embodiment, the present invention can be implemented in a mixed refrigerant LNG system. Examples of mixed refrigerant processes can include, but are not limited to, a single refrigeration system using a mixed refrigerant, a propane pre-cooled mixed refrigerant system, and a dual mixed refrigerant system.

In another embodiment, the present invention is implemented in a cascade LNG system employing a cascade-type refrigeration process using one or more pure component refrigerants. The refrigerants utilized in cascade-type refrigeration processes can have successively lower boiling points in order to maximize heat removal from the natural gas stream being liquefied. Additionally, cascade-type refrigeration processes can include some level of heat integration. For example, a cascade-type refrigeration process can cool one or more refrigerants having a higher volatility via indirect heat exchange with one or more refrigerants having a lower volatility. In addition to cooling the natural gas stream via indirect heat exchange with one or more refrigerants, cascade and mixed-refrigerant LNG systems can employ one or more expansion cooling stages to simultaneously cool the LNG while reducing its pressure to near atmospheric pressure.

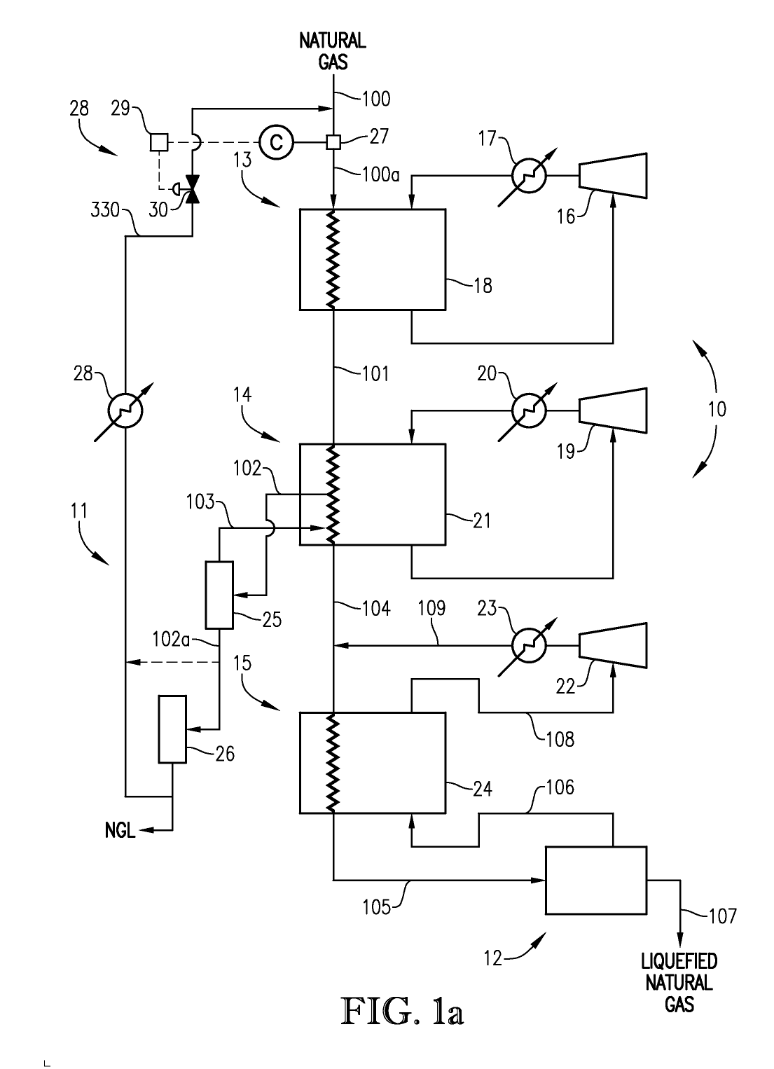

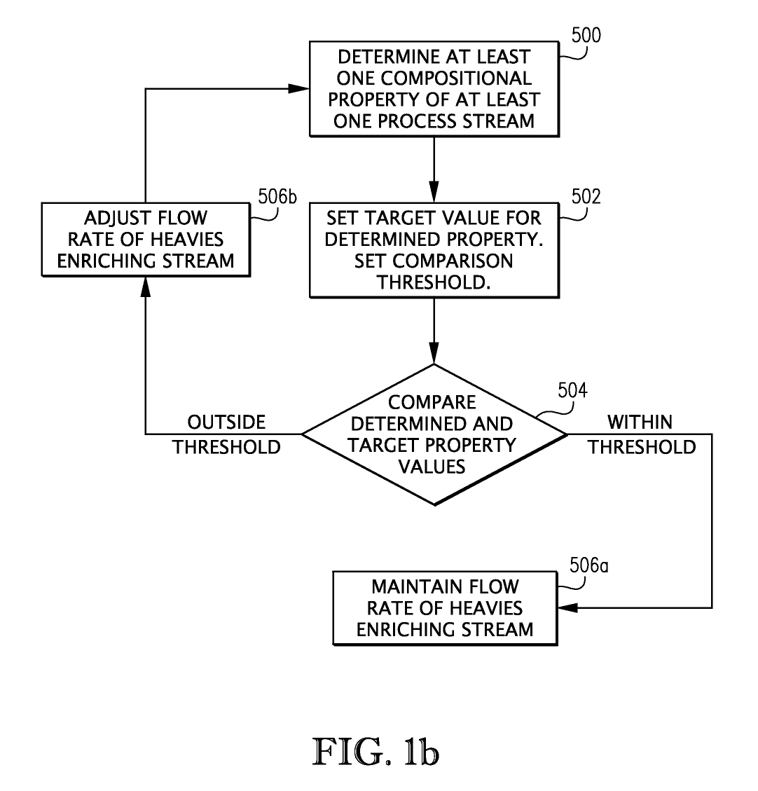

FIG. 1a illustrates one embodiment of a simplified LNG facility employing a heavies recycle stream. The cascade LNG facility of FIG. 1a generally comprises a cascade cooling section 10, a heavies removal zone 11, and an expansion cooling section 12. Cascade cooling section 10 is depicted as comprising a first mechanical refrigeration cycle 13, a second mechanical refrigeration cycle 14, and a third mechanical refrigeration cycle 15. In general, first, second, and third refrigeration cycles 13, 14, 15 can be closed-loop refrigeration cycles, open-loop refrigeration cycles, or any combination thereof. In one embodiment of the present invention, first and second refrigeration cycles 13 and 14 can be closed-loop cycles, and third refrigeration cycle 15 can be an open-loop cycle that utilizes a refrigerant comprising at least a portion of the natural gas feed stream undergoing liquefaction.

In accordance with one embodiment of the present invention, first, second, and third refrigeration cycles 13, 14, 15 can employ respective first, second, and third refrigerants having successively lower boiling points. For example, the first, second, and third refrigerants can have mid-range boiling points at standard pressure (i.e., mid-range standard boiling points) within about 20° F., within about 110° F., or within 5° F. of the standard boiling points of propane, ethylene, and methane, respectively. In one embodiment, the first refrigerant can comprise at least about 75 mole percent, at least about 90 mole percent, at least 95 mole percent, or can consist essentially of propane, propylene, or mixtures thereof. The second refrigerant can comprise at least about 75 mole percent, at least about 90 mole percent, at least 95 mole percent, or can consist essentially of ethane, ethylene, or mixtures thereof. The third refrigerant can comprise at least about 75 mole percent, at least about 90 mole percent, at least 95 mole percent, or can consist essentially of methane.

As shown in FIG. 1a, first refrigeration cycle 13 can comprise a first refrigerant compressor 16, a first cooler 17, and a first refrigerant chiller 18. First refrigerant compressor 16 can discharge a stream of compressed first refrigerant, which can subsequently be cooled and at least partially liquefied in cooler 17. The resulting refrigerant stream can then enter first refrigerant chiller 18, wherein at least a portion of the refrigerant stream can cool the incoming natural gas stream in conduit 100 via indirect heat exchange with the vaporizing first refrigerant. The gaseous refrigerant can exit first refrigerant chiller 18 and can then be routed to an inlet port of first refrigerant compressor 16 to be recirculated as previously described.

First refrigerant chiller 18 can comprise one or more cooling stages operable to reduce the temperature of the incoming natural gas stream in conduit 100 by about 40 to about 210° F., about 50 to about 190° F., or 75 to 150° F. Typically, the natural gas entering first refrigerant chiller 24 via conduit 100 can have a temperature in the range of from about 0 to about 200° F., about 20 to about 180° F., or 50 to 165° F., while the temperature of the cooled natural gas stream exiting first refrigerant chiller 18 can be in the range of from about −65 to about 0° F., about −50 to about −10° F., or −35 to −15° F. In general, the pressure of the natural gas stream in conduit 100 can be in the range of from about 100 to about 3,000 pounds per square inch absolute (psia), about 250 to about 1,000 psia, or 400 to 800 psia. Because the pressure drop across first refrigerant chiller 18 can be less than about 100 psi, less than about 50 psi, or less than 25 psi, the cooled natural gas stream in conduit 101 can have substantially the same pressure as the natural gas stream in conduit 100.

The cooled natural gas stream (also referred to herein as the “cooled predominantly methane stream”) exiting first refrigeration cycle 13 can then enter second refrigeration cycle 14, which can comprise a second refrigerant compressor 19, a second cooler 20, and a second refrigerant chiller 21. Compressed refrigerant can be discharged from second refrigerant compressor 19 and can subsequently be cooled and at least partially liquefied in cooler 20 prior to entering second refrigerant chiller 21. Second refrigerant chiller 21 can employ a plurality of cooling stages to progressively reduce the temperature of the predominantly methane stream in conduit 101 by about 50 to about 180° F., about 65 to about 150° F., or 95 to 125° F. via indirect heat exchange with the vaporizing second refrigerant. As shown in FIG. 1a, the vaporized second refrigerant can then be returned to an inlet port of second refrigerant compressor 19 prior to being recirculated in second refrigeration cycle 14, as previously described.

In one embodiment, the natural gas feed stream in conduit 100 can comprise at least about 5 mole percent, at least about 10 mole percent, or at least 15 mole percent C₂+. The presence of these ethane and heavier components generally results in the formation of a C₂+-rich liquid phase in one or more of the cooling stages of second refrigeration cycle 14. In order to remove the desired heavies, at least a portion of the cooled predominantly methane feed stream passing through second refrigerant chiller 21 can be withdrawn via conduit 102 and processed in heavies removal zone 11. The feed stream entering heavies removal zone 11 in conduit 102 can have a temperature in the range of from about −160 to about −50° F., about −140 to about −65° F., or −115 to −85° F. and a pressure that is within about 5 percent, about 10 percent, or 15 percent of the pressure of the natural gas feed stream in conduit 100.

Heavies removal zone 11 can comprise one or more gas-liquid separators operable to remove at least a portion of the heavy hydrocarbon material from the predominantly methane natural gas stream. In one embodiment, as depicted in FIG. 1a, heavies removal zone 11 comprises a first distillation column 25 and a second distillation column 26. First distillation column 25, also referred to herein as the “heavies removal column,” functions primarily to remove the bulk of the heavy hydrocarbon material, especially components with molecular weights greater than hexane (i.e., C₆+ material) and aromatics such as benzene, toluene, and xylene, which can freeze in downstream processing equipment. The overhead stream exiting heavies removal column 25 via conduit 103 can comprise at least about 75 mole percent, at least about 85 mole percent, at least about 95 mole percent, or at least 99 mole percent methane. Typically, the concentration of C₆+ material in the overhead stream exiting heavies removal column 25 via in conduit 103 can be less than about 0.1 weight percent, less than about 0.05 weight percent, less than about 0.01 weight percent, or less than 0.005 weight percent, based on the total weight of the stream. Generally, heavies removal column 25 can operate with an overhead temperature in the range of from about −200 to about −25° F., about −175 to about −50° F., or about −125 to about −75° F. and an overhead pressure in the range of from about 100 to about 1,000 pounds per square inch absolute (psia), about 250 to about 750 psia, or 400 to 600 psia.

As illustrated in FIG. 1a, a heavies-rich stream having a temperature in the range of from about −20 to about −100° F., about −35 to about −85° F., or −45 to −65° F. can exit first distillation column 25 via conduit 102a, whereafter the stream can enter second distillation column 26. Second distillation column 26, also referred to herein as the “NGL recovery column,” concentrates residual heavy hydrocarbon components into an NGL product stream. Examples of typical hydrocarbon components included in NGL streams can include ethane, propane, butane isomers, pentane isomers, and C₆+ material. The operating conditions (e.g., overhead temperature and pressure) of second distillation column 26 can vary according to the degree of NGL recovery desired. In one embodiment, NGL recovery column 26 can have an overhead temperature in the range of from about 10 to about 80° F., about 20 to about 70° F., or 30 to 60° F. and an overhead pressure in the range of from about 150 to about 900 psia, about 275 to about 725 psia, or about 350 to about 500 psia. The NGL product stream exiting heavies removal zone 11, which can have a temperature in the range of from about 150 to about 350° F., about 200 to about 305° F., or 220 to 280° F., can be subjected to further fractionation (not shown) in order to obtain one or more substantially pure component streams. Often, NGL and/or the substantially pure product streams derived therefrom can be desirable blendstocks for gasoline and other fuels.

According to one embodiment, the natural gas feed stream in conduit 100 can fluctuate between comprising a lean natural gas feed stream and a rich natural gas feed stream. In general, a lean natural gas feed stream can comprise less than about 1 mole percent, less than about 0.5 mole percent, or less than 0.25 mole percent C₃+ components. A rich natural gas stream typically comprises greater than about 1.1 mole percent, greater than about 2 mole percent, or greater than 5 mole percent C₃+ components. In order to produce an on-spec LNG and/or NGL product despite fluctuations in the natural gas feed composition to the plant, the LNG facility depicted in FIG. 1a can employ a heavies enriching stream. A heavies enriching stream can be any stream operable to enrich (i.e., increase the heavies content of) the stream with which it is combined. Typically, the heavies enriching stream can comprise at least about 1 percent, at least about 5 percent, at least about 10 percent, or at least 20 percent more heavy hydrocarbon material than the stream being enriched. In one embodiment, the heavies enriching stream can comprise at least about 50 mole percent, at least about 75 mole percent, or at least about 90 mole percent C₃+ components. Typically, the ratio of the volumetric flow rate of the heavies enriching stream to the volumetric flow rate of the stream being enriched can be in the range of from about 0.0001 to about 0.75, about 0.0005 to about 0.60, or 0.001 to 0.50.

The heavies enriching stream can be withdrawn from one or more of several locations within the LNG facility or can originate from an external source, such as, for example, a gas plant or other location. In one embodiment of the present invention depicted in FIG. 1a, the heavies enriching stream in conduit 330 can originate from the bottom product stream of first and/or second distillation columns 25, 26 in heavies removal zone 11. If desired, a cooler 28 can be employed to cool the heavies enriching stream to a temperature within about 2 to about 50° F., about 5 to about 25° F., or 10 to 15° F. of ambient air or water temperature via indirect heat exchange with an external fluid (e.g., air or water) or an intermediate process stream (not shown). The heavies enriching stream can then be combined with the natural gas feed stream in conduit 100 to produce a heavies enriched natural gas stream in conduit 100a, as shown in FIG. 1a.

Employing a heavies enriching stream can increase overall production of on-spec LNG by helping stabilize plant operations and by increasing the separation efficiency of difficult-to-remove components (e.g., ethane) from the predominantly methane stream processed in heavies removal zone 11. For example, in one embodiment, the molar ratio of the ethane content of the overhead product stream exiting heavies removal column 25 to the ethane content of the bottoms product stream exiting heavies removal column 25 can be less than about 0.25:1, less than about 0.10:1, or less than 0.05:1. Typically, when a heavies enriching stream is employed, an overhead product exiting heavies removal column 25 via conduit 103 can have an ethane content of less than about 10 mole percent, less than about 8 mole percent, less than about 6 mole percent, or less than 5 mole percent. As a result, the LNG produced in the LNG facility can comprise less than about 10 mole percent, less than about 8 mole percent, or less than 6 mole percent C₂+ components. This allows the LNG produced to meet strict market requirements, such as, for example, the North American West Coast specification (NAWC spec), which requires LNG having an ethane content less than 6 mole percent at the product terminal.

Referring now to FIG. 1b, the major steps of one embodiment of a method for utilizing a heavies enriching stream in an LNG facility are presented. First, as depicted in block 500, at least one compositional property of one process stream in the LNG facility can be determined. Suitable process streams can include, for example, the natural gas feed stream (100), the heavies enriched natural gas feed stream (100a), the feed stream to heavies removal zone (102), the heavies enriching stream (330), the overhead and/or bottoms streams from first and/or second distillation columns 25, 26. Examples of determined compositional properties can include, but are not limited to, C₂ content, C₂+ content, C₃ content, C₃+ content, C₃+/C₂ molar ratio, C₃/C₂ molar ratio, molecular weight, and specific gravity, and any combination thereof. The value of the property selected can be determined using any property measurement device, such as, for example, a gas chromatograph (GC), a mass spectrometer, an online analyzer, or any other suitable device for determining the selected compositional property. According to one embodiment depicted in FIG. 1a, a property measurement device 27 can be used to determine the C₃+/C₂ molar ratio in the enriched natural gas feed stream.

As shown by block 502 in FIG. 1b, the next step comprises setting a target value for the stream-specific compositional property determined in the previous step. For example, when the determined compositional property is C₃+/C₂ molar ratio of the heavies enriched natural gas stream, the target value can be at least about 0.3:1, or in the range of from about 0.45:1 to about 10:1, or 0.5:1 to 5.0:1. In addition, as indicated in FIG. 1b, the comparison threshold, or maximum acceptable difference between the target value and the determined value of the compositional property selected, can also be established. In one embodiment, the comparison threshold can be less than about 50 percent, less than about 25 percent, less than about 10 percent, or less than 5 percent.

According to decision block 504, the next step comprises comparing the determined and target property values of the selected stream. If the difference between the target and the determined values are within the comparison threshold established in the previous step, the flow rate of the heavies enriching stream can be maintained at its current rate, as indicated by block 506a. Alternatively, if the difference between the determined value and the target value of the selected compositional property exceeds the threshold limit established in the previous step, the flow rate of the heavies enriching stream can be adjusted accordingly, as shown by block 506b.

Typically, a flow control system can be employed to perform the steps depicted in blocks 504 and 506a,b. One embodiment illustrated in FIG. 1a, a flow control system 28 is illustrated as generally comprising a processor 29 and a flow control device 30. Processor 29 compares the determined value of the property communicated from property measurement device 27 (via an electronic, pneumatic, or other type of signal) to a target value and can manipulate the position of flow control device 30 in order to affect the flow rate of the heavies enriching stream in conduit 330. Flow control device 30 can be a manual flow control valve operated by, for example, a human operator or an automatic flow control valve operated by, for example, a computerized operator. Once the flow rate of the heavies enriching stream has been adjusted, the above-described process should be repeated until an acceptable difference between the target and determined values has been achieved.

Referring back to heavies removal zone 11 illustrated in FIG. 1a, a heavies-depleted, predominantly methane overhead stream can be withdrawn from heavies removal column 25 via conduit 103 prior to being routed back to second refrigeration cycle 14. The stream in conduit 103 can have a temperature in the range of from about −140 to about −50° F., about −125 to about −60° F., or −110 to −75° F. and a pressure in the range of from about 200 to about 1,200 psia, about 350 to about 850 psia, or 500 to 700 psia. As shown in FIG. 1a, the predominantly methane stream in conduit 103 can subsequently be further cooled via second refrigerant chiller 21. In one embodiment, the stream exiting second refrigerant chiller 21 via conduit 104 can be completely liquefied and can have a temperature in the range of from about −205 to about −70° F., about −175 to about −95° F., or −140 to −125° F. Generally, the stream in conduit 104 can be at approximately the same pressure the natural gas stream entering the LNG facility in conduit 100.

As illustrated in FIG. 1a, the pressurized LNG-bearing stream in conduit 104 can combine with a yet-to-be-discussed stream in conduit 109 prior to entering third refrigeration cycle 15, which is depicted as generally comprising a third refrigerant compressor 22, a cooler 23, and a third refrigerant chiller 24. Compressed refrigerant discharged from third refrigerant compressor 22 enters cooler 23, wherein the refrigerant stream is cooled and at least partially liquefied prior to entering third refrigerant chiller 24. Third refrigerant chiller 24 can comprise one or more cooling stages operable to subcool the pressurized predominantly methane stream via indirect heat exchange with the vaporizing refrigerant. In one embodiment, the temperature of the pressurized LNG-bearing stream can be reduced by about 2 to about 60° F., about 5 to about 50° F., or 10 to 40° F. in third refrigerant chiller 24. In general, the temperature of the pressurized LNG-bearing stream exiting third refrigerant chiller 24 via conduit 105 can be in the range of from about −275 to about −75° F., about −225 to about −100° F., or −200 to −125° F.

As shown in FIG. 1a, the pressurized LNG-bearing stream in conduit 105 can be then routed to expansion cooling section 12, wherein the stream is subcooled via sequential pressure reduction to near atmospheric pressure by passage through one or more expansion stages. In one embodiment, each expansion stage can reduce the temperature of the LNG-bearing stream by about 10 to about 60° F., about 15 to about 50° F., or 20 to 40° F. Each expansion stage comprises one or more expansion devices, which reduce the pressure of the liquefied stream to thereby evaporate or flash a portion thereof. Examples of suitable expansion devices can include, but are not limited to, Joule-Thompson valves, venturi nozzles, and turboexpanders. Expansion section 12 can employ any number of expansion stages and one or more expansion stages may be integrated with one or more cooling stages of third refrigerant chiller 24. In one embodiment of the present invention, expansion section 12 can reduce the pressure of the LNG-bearing stream in conduit 105 by about 75 to about 450 psi, about 125 to about 300 psi, or 150 to 225 psi.

Each expansion stage may additionally employ one or more vapor-liquid separators operable to separate the vapor phase (i.e., the flash gas stream) from the cooled liquid stream. As previously discussed, third refrigeration cycle 15 can comprise an open-loop refrigeration cycle, closed-loop refrigeration cycle, or any combination thereof. When third refrigeration cycle 15 comprises a closed-loop refrigeration cycle, the flash gas stream can be used as fuel within the facility or routed downstream for storage, further processing, and/or disposal. When third refrigeration cycle 15 comprises an open-loop refrigeration cycle, at least a portion of the flash gas stream exiting expansion section 12 be used as a refrigerant to cool at least a portion of the natural gas stream in conduit 104. Generally, when third refrigerant cycle 15 comprises an open-loop cycle, the third refrigerant can comprise at least 50 weight percent, at least about 75 weight percent, or at least 90 weight percent of flash gas from expansion section 12, based on the total weight of the stream. As illustrated in FIG. 1a, the flash gas exiting expansion section 12 via conduit 106 can enter third refrigerant chiller 24, wherein the stream can cool at least a portion of the natural gas stream entering third refrigerant chiller 24 via conduit 104. The resulting warmed refrigerant stream can then exit third refrigerant chiller 24 via conduit 108 and can thereafter be routed to an inlet port of third refrigerant compressor 22. As shown in FIG. 1a, third refrigerant compressor 22 discharges a stream of compressed third refrigerant, which is thereafter cooled in cooler 23. The resulting cooled methane stream in conduit 109 can then combine with the natural gas stream in conduit 104 prior to entering third refrigerant chiller 24, as previously discussed.

As shown in FIG. 1a, the liquid stream exiting expansion section 12 via conduit 107 comprises LNG. In one embodiment, the LNG in conduit 107 can have a temperature in the range of from about −200 to about −300° F., about −225 to about −275° F., or −240 to −260° F. and a pressure in the range of from about 0 to about 40 psia, about 5 to about 25 psia, 10 to 20 psia, or about atmospheric. The LNG in conduit 107 can subsequently be routed to storage and/or shipped to another location via pipeline, ocean-going vessel, truck, or any other suitable transportation means. In one embodiment, at least a portion of the LNG can be subsequently vaporized for pipeline transportation or use in applications requiring vapor-phase natural gas.

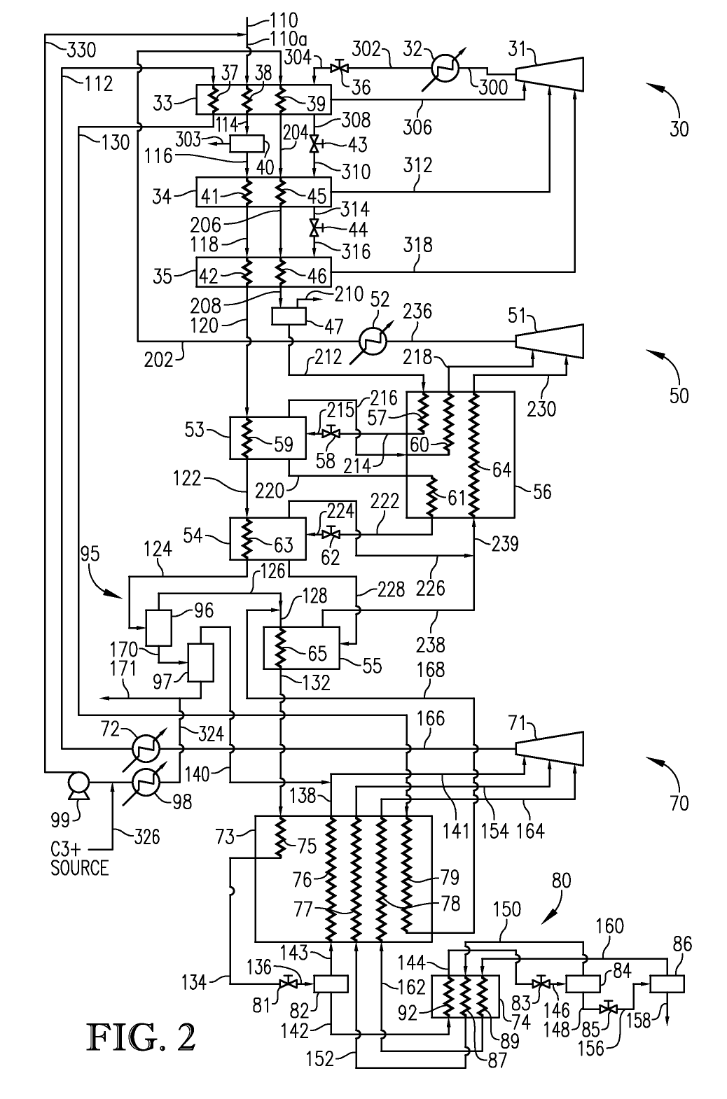

FIG. 2 presents one embodiment of a specific configuration of the LNG facility described previously with respect to FIG. 1a. To facilitate an understanding of FIG. 2, the following numeric nomenclature was employed. Items numbered 31 through 49 are process vessels and equipment directly associated with first propane refrigeration cycle 30, and items numbered 51 through 69 are process vessels and equipment related to second ethylene refrigeration cycle 50. Items numbered 71 through 94 correspond to process vessels and equipment associated with third methane refrigeration cycle 70 and/or expansion section 80. Items numbered 96 through 99 are process vessels and equipment associated with heavies removal zone 95. Items numbered 100 through 199 correspond to flow lines or conduits that contain predominantly methane streams. Items numbered 200 through 299 correspond to flow lines or conduits which contain predominantly ethylene streams. Items numbered 300 through 399 correspond to flow lines or conduits that contain predominantly propane streams.

Referring now to FIG. 2, a cascade-type LNG facility in accordance with one embodiment of the present invention is illustrated. The LNG facility depicted in FIG. 2 generally comprises a propane refrigeration cycle 30, a ethylene refrigeration cycle 50, a methane refrigeration cycle 70 with an expansion section 80, and a heavies removal zone 95. While “propane,” “ethylene,” and “methane” are used to refer to respective first, second, and third refrigerants, it should be understood that the embodiment illustrated in FIG. 2 and described herein can apply to any combination of suitable refrigerants. The main components of propane refrigeration cycle 30 include a propane compressor 31, a propane cooler 32, a high-stage propane chiller 33, an intermediate-stage propane chiller 34, and a low-stage propane chiller 35. The main components of ethylene refrigeration cycle 50 include an ethylene compressor 51, an ethylene cooler 52, a high-stage ethylene chiller 53, an intermediate-stage ethylene chiller 54, a low-stage ethylene chiller/condenser 55, and an ethylene economizer 56. The main components of methane refrigeration cycle 70 include a methane compressor 71, a methane cooler 72, a main methane economizer 73, and a secondary methane economizer 74. The main components of expansion section 80 include a high-stage methane expansion device 81, a high-stage methane flash drum 82, an intermediate-stage methane expansion device 83, an intermediate-stage methane flash drum 84, a low-stage methane expansion device 85, and a low-stage methane flash drum 86. The LNG facility of FIG. 2 also includes heavies removal zone located downstream of intermediate-stage ethylene chiller 54 for removing heavy hydrocarbon components from the processed natural gas and recovering the resulting natural gas liquids. The heavies removal zone 95 of FIG. 2 is shown as generally comprising a first distillation column 96 and a second distillation column 97.

The operation of the LNG facility illustrated in FIG. 2 will now be described in more detail, beginning with propane refrigeration cycle 30. Propane is compressed in multi-stage (e.g., three-stage) propane compressor 31 driven by, for example, a gas turbine driver (not illustrated). The three stages of compression preferably exist in a single unit, although each stage of compression may be a separate unit and the units mechanically coupled to be driven by a single driver. Upon compression, the propane is passed through conduit 300 to propane cooler 32, wherein it is cooled and liquefied via indirect heat exchange with an external fluid (e.g., air or water). A representative temperature and pressure of the liquefied propane refrigerant exiting cooler 32 is about 100° F. and about 190 psia. The stream from propane cooler 32 can then be passed through conduit 302 to a pressure reduction means, illustrated as expansion valve 36, wherein the pressure of the liquefied propane is reduced, thereby evaporating or flashing a portion thereof. The resulting two-phase stream then flows via conduit 304 into high-stage propane chiller 33. High stage propane chiller 33 uses indirect heat exchange means 37, 38, and 39 to cool respectively, the incoming gas streams, including a yet-to-be-discussed methane refrigerant stream in conduit 112, a yet-to-be-discussed heavies enriched natural gas feed stream in conduit 110a, and a yet-to-be-discussed ethylene refrigerant stream in conduit 202 via indirect heat exchange with the vaporizing refrigerant. The cooled methane refrigerant stream exits high-stage propane chiller 33 via conduit 130 and can subsequently be routed to the inlet of main methane economizer 73, which will be discussed in greater detail in a subsequent section.

The cooled natural gas stream from high-stage propane chiller 33 (also referred to herein as the “methane-rich stream”) flows via conduit 114 to a separation vessel 40, wherein the gaseous and liquid phases are separated. The liquid phase, which can be rich in propane and heavier components (C₃+), is removed via conduit 303. The predominately vapor phase exits separator 40 via conduit 116 and can then enter intermediate-stage propane chiller 34, wherein the stream is cooled in indirect heat exchange means 41 via indirect heat exchange with a yet-to-be-discussed propane refrigerant stream. The resulting two-phase methane-rich stream in conduit 118 can then be routed to low-stage propane chiller 35, wherein the stream can be further cooled via indirect heat exchange means 42. The resultant predominantly methane stream can then exit low-stage propane chiller 35 via conduit 120. Subsequently, the cooled methane-rich stream in conduit 120 can be routed to high-stage ethylene chiller 53, which will be discussed in more detail shortly.

The vaporized propane refrigerant exiting high-stage propane chiller 33 is returned to the high-stage inlet port of propane compressor 31 via conduit 306. The residual liquid propane refrigerant in high-stage propane chiller 33 can be passed via conduit 308 through a pressure reduction means, illustrated here as expansion valve 43, whereupon a portion of the liquefied refrigerant is flashed or vaporized. The resulting cooled, two-phase refrigerant stream can then enter intermediate-stage propane chiller 34 via conduit 310, thereby providing coolant for the natural gas stream and yet-to-be-discussed ethylene refrigerant stream entering intermediate-stage propane chiller 34. The vaporized propane refrigerant exits intermediate-stage propane chiller 34 via conduit 312 and can then enter the intermediate-stage inlet port of propane compressor 31. The remaining liquefied propane refrigerant exits intermediate-stage propane chiller 34 via conduit 314 and is passed through a pressure-reduction means, illustrated here as expansion valve 44, whereupon the pressure of the stream is reduced to thereby flash or vaporize a portion thereof. The resulting vapor-liquid refrigerant stream then enters low-stage propane chiller 35 via conduit 316 and cools the methane-rich and yet-to-be-discussed ethylene refrigerant streams entering low-stage propane chiller 35 via conduits 118 and 206, respectively. The vaporized propane refrigerant stream then exits low-stage propane chiller 35 and is routed to the low-stage inlet port of propane compressor 31 via conduit 318 wherein it is compressed and recycled as previously described.

As shown in FIG. 2, a stream of ethylene refrigerant in conduit 202 enters high-stage propane chiller, wherein the ethylene stream is cooled via indirect heat exchange means 39. The resulting cooled stream in conduit 204 then exits high-stage propane chiller 33, whereafter the at least partially condensed stream enters intermediate-stage propane chiller 34. Upon entering intermediate-stage propane chiller 34, the ethylene refrigerant stream can be further cooled via indirect heat exchange means 45. The resulting two-phase ethylene stream can then exit intermediate-stage propane chiller 34 prior to entering low-stage propane chiller 35 via conduit 206. In low-stage propane chiller 35, the ethylene refrigerant stream can be at least partially condensed, or condensed in its entirety, via indirect heat exchange means 46. The resulting stream exits low-stage propane chiller 35 via conduit 208 and can subsequently be routed to a separation vessel 47, wherein the vapor portion of the stream, if present, can be removed via conduit 210. The liquefied ethylene refrigerant stream exiting separator 47 via conduit 212 can have a representative temperature and pressure of about −24° F. and about 285 psia.

Turning now to ethylene refrigeration cycle 50 in FIG. 2, the liquefied ethylene refrigerant stream in conduit 212 can enter ethylene economizer 56, wherein the stream can be further cooled by an indirect heat exchange means 57. The sub-cooled liquid ethylene stream in conduit 214 can then be routed through a pressure reduction means, illustrated here as expansion valve 58, whereupon the pressure of the stream is reduced to thereby flash or vaporize a portion thereof. The cooled, two-phase stream in conduit 215 can then enter high-stage ethylene chiller 53, wherein at least a portion of the ethylene refrigerant stream can vaporize to thereby cool the methane-rich stream entering an indirect heat exchange means 59 of high-stage ethylene chiller 53 via conduit 120. The vaporized and remaining liquefied refrigerant exit high-stage ethylene chiller 53 via respective conduits 216 and 220. The vaporized ethylene refrigerant in conduit 216 can re-enter ethylene economizer 56, wherein the stream can be warmed via an indirect heat exchange means 60 prior to entering the high-stage inlet port of ethylene compressor 51 via conduit 218, as shown in FIG. 2.

The remaining liquefied refrigerant in conduit 220 can re-enter ethylene economizer 56, wherein the stream can be further sub-cooled by an indirect heat exchange means 61. The resulting cooled refrigerant stream exits ethylene economizer 56 via conduit 222 and can subsequently be routed to a pressure reduction means, illustrated here as expansion valve 62, whereupon the pressure of the stream is reduced to thereby vaporize or flash a portion thereof. The resulting, cooled two-phase stream in conduit 224 enters intermediate-stage ethylene chiller 54, wherein the refrigerant stream can cool the natural gas stream in conduit 122 entering intermediate-stage ethylene chiller 54 via an indirect heat exchange means 63. As shown in FIG. 2, the resulting cooled methane-rich stream exiting intermediate stage ethylene chiller 54 can then be routed to heavies removal zone 95. Heavies removal zone 95 will be discussed in detail in a subsequent section.

The vaporized ethylene refrigerant exits intermediate-stage ethylene chiller 54 via conduit 226, whereafter the stream can combine with a yet-to-be-discussed ethylene vapor stream in conduit 238. The combined stream in conduit 239 can enter ethylene economizer 56, wherein the stream is warmed in an indirect heat exchange means 64 prior to being fed into the low-stage inlet port of ethylene compressor 51 via conduit 230. As shown in FIG. 2, a stream of compressed ethylene refrigerant in conduit 236 can subsequently be routed to ethylene cooler 52, wherein the ethylene stream can be cooled via indirect heat exchange with an external fluid (e.g., water or air). The resulting, at least partially condensed ethylene stream can then be introduced via conduit 202 into high-stage propylene chiller 33 for additional cooling as previously described.

The remaining liquefied ethylene refrigerant exits intermediate-stage ethylene chiller 54 via conduit 228 prior to entering low-stage ethylene chiller/condenser 55, wherein the refrigerant can cool the methane-rich stream entering low-stage ethylene chiller/condenser via conduit 128 in an indirect heat exchange means 65. In one embodiment shown in FIG. 2, the stream in conduit 128 results from the combination of a heavies-depleted (i.e., light hydrocarbon rich) stream exiting heavies removal zone 95 via conduit 126 and a yet-to-be-discussed methane refrigerant stream in conduit 168. As shown in FIG. 2, the vaporized ethylene refrigerant can then exit low-stage ethylene chiller/condenser 55 via conduit 238 prior to combining with the vaporized ethylene exiting intermediate-stage ethylene chiller 54 and entering the low-stage inlet port of ethylene compressor 51, as previously discussed.

The cooled natural gas stream exiting low-stage ethylene chiller/condenser can also be referred to as the “pressurized LNG-bearing stream.” As shown in FIG. 2, the pressurized LNG-bearing stream exits low-stage ethylene chiller/condenser 55 via conduit 132 prior to entering main methane economizer 73. In main methane economizer 73, the methane-rich stream can be cooled in an indirect heat exchange means 75 via indirect heat exchange with one or more yet-to-be discussed methane refrigerant streams. The cooled, pressurized LNG-bearing stream exits main methane economizer 73 and can then be routed via conduit 134 into expansion section 80 of methane refrigeration cycle 70. In expansion section 80, the cooled predominantly methane stream passes through high-stage methane expansion device 81, whereupon the pressure of the stream is reduced to thereby vaporize or flash a portion thereof. The resulting two-phase methane-rich stream in conduit 136 can then enter high-stage methane flash drum 82, whereupon the vapor and liquid portions can be separated. The vapor portion exiting high-stage methane flash drum 82 (i.e., the high-stage flash gas) via conduit 143 can then enter main methane economizer 73, wherein the stream is heated via indirect heat exchange means 76. The resulting warmed vapor stream exits main methane economizer 73 and subsequently combines with a yet-to-be-discussed vapor stream exiting heavies removal zone 95 in conduit 140. The combined stream in conduit 141 can then be routed to the high-stage inlet port of methane compressor 71, as shown in FIG. 2.

The liquid phase exiting high-stage methane flash drum 82 via conduit 142 can enter secondary methane economizer 74, wherein the methane stream can be cooled via indirect heat exchange means 92. The resulting cooled stream in conduit 144 can then be routed to a second expansion stage, illustrated here as intermediate-stage expansion device 83. Intermediate-stage expansion device 83 reduces the pressure of the methane stream passing therethrough to thereby reduce the stream's temperature by vaporizing or flashing a portion thereof. The resulting two-phase methane-rich stream in conduit 146 can then enter intermediate-stage methane flash drum 84, wherein the liquid and vapor portions of the stream can be separated and can exit the intermediate-stage flash drum via respective conduits 148 and 150. The vapor portion (i.e., the intermediate-stage flash gas) in conduit 150 can re-enter secondary methane economizer 74, wherein the stream can be heated via an indirect heat exchange means 87. The warmed stream can then be routed via conduit 152 to main methane economizer 73, wherein the stream can be further warmed via an indirect heat exchange means 77 prior to entering the intermediate-stage inlet port of methane compressor 71 via conduit 154.

The liquid stream exiting intermediate-stage methane flash drum 84 via conduit 148 can then pass through a low-stage expansion device 85, whereupon the pressure of the liquefied methane-rich stream can be further reduced to thereby vaporize or flash a portion thereof. The resulting cooled, two-phase stream in conduit 156 can then enter low-stage methane flash drum 86, wherein the vapor and liquid phases can be separated. The liquid stream exiting low-stage methane flash drum 86 can comprise the liquefied natural gas (LNG) product. The LNG product, which is at about atmospheric pressure, can be routed via conduit 158 downstream for subsequent storage, transportation, and/or use.

The vapor stream exiting low-stage methane flash drum (i.e., the low-stage methane flash gas) in conduit 160 can be routed to secondary methane economizer 74, wherein the stream can be warmed via an indirect heat exchange means 89. The resulting stream can exit secondary methane economizer 74 via conduit 162, whereafter the stream can be routed to main methane economizer 73 to be further heated via indirect heat exchange means 78. The warmed methane vapor stream can then exit main methane economizer 73 via conduit 164 prior to being routed to the low-stage inlet port of methane compressor 71. Methane compressor 71 can comprise one or more compression stages. In one embodiment, methane compressor 71 comprises three compression stages in a single module. In another embodiment, the compression modules can be separate, but can be mechanically coupled to a common driver. Generally, when methane compressor 71 comprises two or more compression stages, one or more intercoolers (not shown) can be provided between subsequent compression stages. As shown in FIG. 2, the compressed methane refrigerant stream exiting methane compressor 71 can be discharged into conduit 166, whereafter the stream can be cooled via indirect heat exchange with an external fluid (e.g., air or water) in methane cooler 72. The cooled methane refrigerant stream exiting methane cooler 72 can then enter conduit 112, whereafter the methane refrigerant stream can be further cooled in propane refrigeration cycle 30, as described in detail previously.

Upon being cooled in propane refrigeration cycle 30, the methane refrigerant stream can be discharged into conduit 130 and subsequently routed to main methane economizer 73, wherein the stream can be further cooled via indirect heat exchange means 79. The resulting sub-cooled stream exits main methane economizer 73 via conduit 168 and can then combined with the heavies-depleted stream exiting heavies removal zone 95 via conduit 126, as previously discussed.

Turning now to heavies removal zone 95, the cooled, at least partially condensed effluent exiting intermediate-stage ethylene chiller 54 via conduit 124 can be routed into the inlet of first distillation column 96, as shown in FIG. 2. A predominantly methane overhead vapor product stream can exit an upper outlet of first distillation column 96 via conduit 126. As discussed previously, the stream in conduit 126 can subsequently combine with the methane refrigerant stream in conduit 168 prior to entering low-stage ethylene chiller/condenser 55 via conduit 128. Referring back to heavies removal zone 95, a heavies-rich bottoms liquid product stream exiting a lower outlet of first distillation column 96 via conduit 170 can then be routed to an inlet of second distillation column 97. An overhead vapor product stream can exit an upper outlet of second distillation column 97 via conduit 140 prior to being combined with the warmed methane refrigerant stream in conduit 138, as discussed in detail previously. The bottoms liquid product exiting a lower outlet of second distillation column 97 can comprise the natural gas liquids (NGL) product. The NGL product, which can comprise a significant concentration of butane and heavier hydrocarbons, such as benzene, cyclohexane, and other aromatics, can be routed to further storage, processing, and/or use via conduit 171.

As illustrated in FIG. 2, at least a portion of the NGL product exiting the lower outlet of second distillation column 97 in conduit 171 can be withdrawn via conduit 324 and subsequently cooled via indirect heat exchange with an external fluid (e.g., air or water) in cooler 98. Optionally, a heavies stream originating from an external C₃+ source (e.g., a gas plant or other storage location) via conduit 326 can be routed into the LNG facility depicted in FIG. 1 and can combine with the cooled stream exiting cooler 98. The resulting stream can then enter the suction of pump 99, whereafter the pressurized stream can be discharged into conduit 330. The heavies enriching stream in conduit 330 can then be routed to combine with the natural gas feed stream in conduit 110 to thereby produce the heavies enriched natural gas feed stream in conduit 110a, as shown in FIG. 2. The heavies enriched natural gas stream can then continue through the LNG facility as previously described.

In one embodiment of the present invention, the LNG production systems illustrated in FIGS. 1a and 2 are simulated on a computer using conventional process simulation software in order to generate process simulation data in a human-readable form. In one embodiment, the process simulation data can be in the form of a computer print out. In another embodiment, the process simulation data can be displayed on a screen, a monitor, or other viewing device. The simulation data can then be used to manipulate the LNG system. In one embodiment, the simulation results can be used to design a new LNG facility and/or revamp or expand an existing facility. In another embodiment, the simulation results can be used to optimize the LNG facility according to one or more operating parameters. Examples of suitable software for producing the simulation results include HYSYS™ or Aspen Plus® from Aspen Technology, Inc., and PRO/II® from Simulation Sciences Inc.

### EXAMPLE

The LNG facility depicted in FIG. 2 was simulated using HYSYS™ simulation software to illustrate the effect of the heavies enriching stream on the composition of the LNG product. The ratio of the volumetric flow rate of the heavies enriching stream in conduit 330 to the volumetric flow rate of the natural gas stream in conduit 110 was varied in order to achieve various C₃+/C₂ ratios in the heavies enriched natural gas feed stream in conduit 110a. The composition of the overhead product stream of first distillation column 96 in conduit 126 was determined for each trial run and the results for are presented in Table 1, below. First distillation column 96 was simulated at an overhead temperature of −107° F. and an overhead pressure of 500 psia.

TABLE 1
Results of HYSIS ™ Simulation for Various Heavies
Enriched Feed Stream Compositions

| Volumetric Ratio of | C₃+/C₂ Molar Ratio in | Mole % C₂ in First |
|---|---|---|
| Heavies Enriching Stream | Heavies Enriched Feed | Distillation Column |
| (330) to Feed Stream (110) | Stream (110a) | Overhead (126) |
| 0 | 0.03 | 6.18 |
| 0.005 | 0.08 | 5.80 |
| 0.01 | 0.19 | 5.46 |
| 0.02 | 0.22 | 4.89 |
| 0.03 | 0.32 | 4.43 |
| 0.04 | 0.42 | 4.06 |
| 0.044 | 0.45 | 3.93 |

As illustrated by the results presented in Table 1, increasing the volumetric flow rate of the heavies enriching stream introduced into the natural gas feed stream (to thereby increase the C₃+/C₂ molar ratio in the enriched heavies removal stream) reduces the ethane content of the overhead stream withdrawn from first distillation column 96. Because the overhead stream exiting first distillation column 96 ultimately becomes the final LNG product, utilizing a heavies enriching stream can help control the ethane content of the final LNG product.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds).

### DEFINITIONS

As used herein, the terms “a,” “an,” “the,” and “said” means one or more.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “cascade-type refrigeration process” refers to a refrigeration process that employs a plurality of refrigeration cycles, each employing a different refrigerant to successively cool natural gas.

As used herein, the term “closed-loop refrigeration cycle” refers to a refrigeration cycle wherein substantially no refrigerant enters or exits the cycle during normal operation.

As used herein, the term “compositional property” refers to a property associated with the composition of a stream.

As used herein, the terms “comprising,” “comprises,” and “comprise” are open-ended transition terms used to transition from a subject recited before the term to one or elements recited after the term, where the element or elements listed after the transition term are not necessarily the only elements that make up of the subject.

As used herein, the terms “containing,” “contains,” and “contain” have the same open-ended meaning as “comprising,” “comprises,” and “comprise,” provided above.

As used herein, the terms “economizer” or “economizing heat exchanger” refer to a configuration utilizing a plurality of heat exchangers employing indirect heat exchange means to efficiently transfer heat between process streams.

As used herein, the terms “having,” “has,” and “have” have the same open-ended meaning as “comprising,” “comprises,” and “comprise,” provided above.

As used herein, the term “heavies enriching stream” refers to any stream operable to enrich (i.e., increase the heavies content of) the stream with which it is combined.

As used herein, the terms “heavy hydrocarbon” and “heavies” refer to any component that is less volatile (i.e., has a higher boiling point) than methane.

As used herein, the terms “including,” “includes,” and “include” have the same open-ended meaning as “comprising,” “comprises,” and “comprise,” provided above.

As used herein, the term “lean natural gas” refers to natural gas comprising less than about 1 mole percent C₃+ material.

As used herein, the term “mid-range standard boiling point” refers to the temperature at which half of the weight of a mixture of physical components has been vaporized (i.e., boiled off) at standard pressure.

As used herein, the term “mixed refrigerant” refers to a refrigerant containing a plurality of different components, where no single component makes up more than 75 mole percent of the refrigerant.

As used herein, the term “natural gas” means a stream containing at least 75 mole percent methane, with the balance being ethane, higher hydrocarbons, nitrogen, carbon dioxide, and/or a minor amount of other contaminants such as mercury, hydrogen sulfide, and mercaptan.

As used herein, the terms “natural gas liquids” or “NGL” refer to mixtures of hydrocarbons whose components are, for example, typically heavier than ethane. Some examples of hydrocarbon components of NGL streams include propane, butane, and pentane isomers, benzene, toluene, and other aromatic compounds.

As used herein, the term “open-loop refrigeration cycle” refers to a refrigeration cycle wherein at least a portion of the refrigerant employed during normal operation originates from the fluid being cooled by the refrigeration cycle.

As used herein, the terms “predominantly,” “primarily,” “principally,” and “in major portion,” when used to describe the presence of a particular component of a fluid stream, means that the fluid stream comprises at least 50 mole percent of the stated component. For example, a “predominantly” methane stream, a “primarily” methane stream, a stream “principally” comprised of methane, or a stream comprised “in major portion” of methane each denote a stream comprising at least 50 mole percent methane.

As used herein, the term “pure component refrigerant” means a refrigerant that is not a mixed refrigerant.

As used herein, the term “rich natural gas” refers to natural gas having greater than about 1.1 mole percent C₃+ material.

As used herein, the terms “upstream” and “downstream” refer to the relative positions of various components of a natural gas liquefaction facility along the main flow path of natural gas through the facility.

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A process for liquefying a natural gas stream in an LNG facility, said process comprising:
(a) combining at least a portion of said natural gas stream with a heavies enriching stream to thereby form a heavies enriched natural gas stream;
(b) separating at least a portion of said heavies enriched natural gas stream in a first distillation column to thereby provide a first overhead stream and a first bottoms stream; and
(c) separating at least a portion of said first bottoms stream in a second distillation column to thereby provide a second bottoms stream, wherein said heavies enriching stream comprises at least a portion of said second bottoms stream.

2. The process of claim 1, wherein said heavies enriching stream comprises at least about 50 mole percent C₃+ components.

3. The process of claim 1, wherein said natural gas stream comprises less than about 1 mole percent C₃+ components.

4. The process of claim 3, wherein said heavies enriched natural gas stream has a C₃+/C₂ molar ratio of at least about 0.3:1.

5. The process of claim 3, wherein the molar ratio of the ethane content of said first overhead stream to the ethane content of said first bottoms stream is less than about 0.25:1.

6. The process of claim 1, further comprising using a fraction of said second bottoms stream as said heavies enriching stream.

7. The process of claim 6, further comprising cooling said heavies enriching stream prior to said combining of step (a).

8. The process of claim 1, further comprising determining at least one compositional property of said natural gas stream, said heavies enriched natural gas stream, and/or said first overhead stream and adjusting the flow rate of said heavies enriching stream based at least partially on the determined compositional property.

9. The process of claim 8, wherein the determined compositional property is C₂ content, C₂+ content, C₃ content, C₃+ content, and/or C₃+/C₂ molar ratio.

10. The process of claim 8, wherein the flow rate of said heavies enriching stream is adjusted to maintain the C₃+/C₂ molar ratio of said heavies enriched natural gas stream in the range of from about 0.45:1 to about 15:1.

11. The process of claim 1, further comprising, upstream of said first distillation column, cooling at least a portion of said heavies enriched natural gas stream in a first refrigeration cycle via indirect heat exchange with a first refrigerant.

12. The process of claim 11, wherein said first refrigerant comprises a pure component refrigerant.

13. The process of claim 11, wherein said first refrigerant comprises predominantly propane, propylene, ethane, or ethylene.

14. The process of claim 1, further comprising cooling at least a portion of said first overhead steam to thereby produce LNG comprising less than about 8 mole percent of C₂+ components.

15. The process of claim 1, wherein said first distillation column operates at an overhead pressure in the range of from about 400 to about 600 psia and an overhead temperature in the range of from about −175 to about −50° F.

16. The process of claim 1, wherein said LNG facility employs successive propane, ethylene, and methane refrigeration cycles.

17. The process of claim 1, further comprising vaporizing LNG produced via steps (a)-(c).

18. A computer simulation process comprising utilizing a computer to simulate the process of claim 1 and to generate process simulation data in a human-readable form.

19. A process for liquefying a natural gas stream in an LNG facility, said process comprising:
(a) introducing a heavies enriching stream into said natural gas stream to thereby produce a heavies enriched natural gas stream;
(b) separating at least a portion of said heavies enriched natural gas stream in a distillation column to thereby provide an overhead stream and a bottoms stream, wherein said heavies enriching stream comprises at least a portion of said bottoms stream; and
(c) adjusting the flow rate of said heavies enriching stream introduced into said natural gas stream to maintain a C₃+/C₂ molar ratio of said heavies enriched natural gas stream of at least about 0.3:1.

20. The process of claim 19, wherein said heavies enriching stream comprises at least about 50 mole percent C₃+.

21. The process of claim 19, further comprising determining a compositional property of one or more of said natural gas stream, said heavies enriched natural gas stream, said heavies enriching stream, said overhead stream, and/or said bottoms stream, wherein said adjusting of step (c) is at least partially based on the determined compositional property.

22. The process of claim 19, wherein said adjusting of step (c) comprises manipulating a manual flow control valve.

23. The process of claim 19, wherein said adjusting of step (c) comprises manipulating an automatic flow control valve.

24. The process of claim 19, wherein said natural gas stream comprises less than about 1 mole percent C₃+.

25. The process of claim 19, wherein the molar ratio of the ethane content of said overhead stream to the ethane content of said bottoms stream is less than about 0.25:1.

26. The process of claim 19, further comprising cooling at least a portion of said overhead stream to thereby produce LNG having less than about 8 mole percent of C₂+ components.

27. The process of claim 19, further comprising cooling at least a portion of said heavies enriched natural gas stream in a first refrigeration cycle via indirect heat exchange with a first refrigerant.

28. The process of claim 27, wherein said first refrigerant comprises predominantly propane, propylene, ethane, and/or ethylene.

29. The process of claim 19, wherein said LNG facility employs successive propane, ethylene, and methane refrigeration cycles.

30. An LNG facility comprising:
a natural gas feed conduit;
a first distillation column defining a first fluid inlet, a first upper outlet, and a first lower outlet, wherein said natural gas feed conduit is coupled in fluid flow communication with said first fluid inlet; and
a second distillation column defining a second fluid inlet, a second upper outlet, and a second lower outlet, wherein said first lower outlet is coupled in fluid flow communication with said second fluid inlet, wherein said second lower outlet is coupled in fluid flow communication with said natural gas feed conduit at an enrichment location upstream of said first distillation column.

31. The LNG facility of claim 30, further comprising a property measurement device coupled in fluid flow communication with said natural gas feed conduit, said first upper outlet, said first lower outlet, said second upper outlet, and/or said second lower outlet, wherein said property measurement device is operable to determine at least one fluid compositional property.

32. The LNG facility of claim 31, further comprising a flow control system for adjusting the rate of fluid flow from said second lower outlet to said enrichment location based on the fluid compositional property determined by said property measurement device.

33. The LNG facility of claim 30, further comprising a heat exchanger interposed in said natural gas feed conduit downstream of said enrichment location and operable to cool fluid flowing through said natural gas feed conduit.

34. The LNG facility of claim 30, further comprising successive propane and ethylene refrigeration cycles interposed along said natural gas feed conduit.
